(19) United States
(12) Patent Application Publication
(10) Pub. No.: US 2006/0174511 A1
(43) Pub. Date: Aug. 10, 2006

(54) Clothes drying machine

(75) Inventors: Jung Ho Lee, Seoul (KR); Suk Ho Chung, Seoul (KR); Young Suk Chung, Suwon-Si (KR); Sang Hee Won, Seoul (KR); Seong Ha Hwang, Suwon-Si (KR); Seung Kwan Ryu, Suwon-Si (KR); Kil Nam Kim, Choongnam (KR); Min Kuk Kim, Goyang-Si (KR); Seung Suk Yoon, Anyang-Si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/258,109

(22) Filed: Oct. 26, 2005

(30) Foreign Application Priority Data
Feb. 4, 2005 (KR) 2005-10689

(51) Int. Cl. F26B 11/02; D06F 58/00

(52) U.S. Cl. 34/605; 34/134

(57) ABSTRACT

A clothes drying machine, in which the installation position of a temperature sensor is optimized to minimize the interruption of the operation of a burner, thereby shortening the drying time of laundry. The clothes drying machine includes a suction duct for guiding air to be introduced to a rotary drum; a burner for heating air introduced into the suction duct; and a temperature sensor installed in the suction duct for controlling the operation of the burner, wherein the temperature sensor is installed at a position separated from an inlet of the suction duct by a designated distance, and the ratio of the distance to a diameter of the inlet of the suction duct is 0.9˜1.

### CROSS-REFERENCE TO RELATED APPLICATION

This application claims priority from Korean Patent Application No. 2005-10689, filed Feb. 4, 2005, in the Korean Intellectual Property Office, the disclosure of which is incorporated herein by reference.

### BACKGROUND OF THE INVENTION

1. Field of the Invention

The present invention relates to a clothes drying machine and, more particularly, to a clothes drying machine in which the installation position of a temperature sensor is optimized to minimize the interruption of the operation of a burner.

2. Description of the Related Art

A general drum-type clothes drying machine allows hot air to pass through the inside of a rotary drum under the condition that the rotary drum containing laundry is rotated at a low speed, thereby drying the laundry in the rotary drum. Korean Patent Laid-open Publication No. 2004-0023997 discloses such a clothes drying machine.

The above clothes drying machine comprises an air blowing device for blowing air to the inside of the rotary drum, a driving motor for simultaneously driving the air blowing device and the rotary drum, a suction channel for guiding air to be introduced into the rotary drum, a burner for emitting a flame to the suction channel for heating air supplied to the rotary drum, and a discharge channel for guiding air to be discharged from the rotary drum to the outside. The clothes drying machine dries laundry in the rotary drum by heating the sucked in air using the flame of the burner and introducing the heated air to the inside of the rotary drum through the suction channel. The air in the rotary drum is discharged to the outside of the discharge channel.

In the structure of the clothes drying machine, the overheating of the suction channel is prevented by sensing the temperature of the suction channel and controlling the operation of the burner. The above structure prevents the sucked in air from being overheated when the amount of air passing through the rotary drum is reduced due to a difficulty in flowing the air in the discharge channel by laundry or lint. That is, whether or not the suction channel is overheated is sensed by a temperature sensor at the suction channel and the operation of the burner and the air blowing device is controlled, thereby preventing the air in the suction channel from being overheated. This configuration prevents the sucked in air introduced into the rotary drum from being overheated, thereby protecting laundry in the rotary drum.

However, in the above clothes drying machine, even when the temperature of the air introduced into the rotary drum does not substantially reach the upper limit and the air does not cause any problem in drying the laundry in the rotary drum, the temperature of the spot at the position at which the temperature sensor is installed reaches the upper limit and the operation of the burner may be unnecessarily stopped. That is, even when the degree of the clogging of the channel (channel resistance) is not high, the temperature sensor (thermostat) is operated so that the operation of the burner is stopped. The stoppage of the operation of the burner is maintained until the temperature of the temperature sensor is lowered. The repetition of the above operation of the burner causes delay in a drying time of the laundry.

### SUMMARY OF THE INVENTION

Therefore, an aspect of the invention is to provide a clothes drying machine, in which the installation position of a temperature sensor is optimized to minimize the interruption of the operation of a burner, thereby shortening a drying time.

An apparatus consistent with the present invention relates to a clothes drying machine, comprising: a suction duct for guiding air to be introduced to a rotary drum; a burner for heating air introduced into the suction duct; and a temperature sensor installed in the suction duct for controlling the operation of the burner, wherein the temperature sensor is installed at a position separated from an inlet of the suction duct by a designated distance, and the ratio of the distance to a diameter of the inlet of the suction duct is 0.9˜1.

Preferably, but not necessarily, the ratio of the distance to the diameter of the inlet of the suction duct may be 0.95.

Further, the diameter of the inlet of the suction duct may be 140˜150 mm, and the length of flame emitted from the burner may be 140˜160 mm.

Moreover, the suction duct may have a conical structure, the diameter of which is reduced from the inlet to the outlet.

The temperature sensor may be a thermostat.

Further, the suction duct may include a lower suction duct installed below the rotary drum, and a rear suction duct installed at the rear of the rotary drum; and the temperature sensor may be installed in the lower suction duct.

### BRIEF DESCRIPTION OF THE DRAWINGS

These and/or other aspects and advantages of the invention will become apparent and more readily appreciated from the following description of the exemplary embodiments, taken in conjunction with the accompanying drawings, in which:

FIG. 1 is a sectional view of a clothes drying machine consistent with the present invention;

FIG. 2 is an exploded perspective view illustrating the installation structure of a lower suction duct and a temperature sensor of the clothes drying machine of the present invention; and

FIG. 3 is a graph illustrating variation in temperature according to variation in channel resistance under the condition that the installation conditions of the temperature sensor of the clothes drying machine are different.

### DETAILED DESCRIPTION OF THE ILLUSTRATIVE, NON-LIMITING EMBODIMENTS OF THE INVENTION

Reference will now be made in detail to the illustrative, non-limiting embodiment of the present invention, an example of which is illustrated in the accompanying drawings, wherein like reference numerals refer to like elements throughout. The exemplary embodiment is described below to explain the present invention by referring to the accompanying drawings.

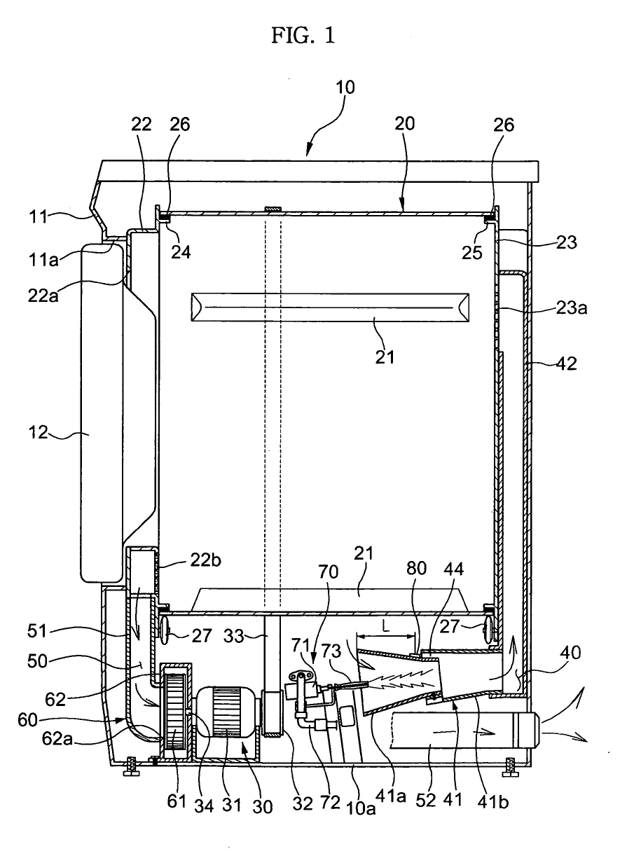

As shown in FIG. 1, the clothes drying machine of the present invention comprises a rotary drum 20 rotatably installed in an external case 10, a driving device 30 for rotating the rotary drum 20, a suction channel 40 and a discharge channel 50 for circulating air to the inside of the rotary drum 20, an air blowing device 60 for blowing air, and a burner 70 for heating air introduced into the suction channel 40.

The rotary drum 20 has a cylindrical structure, front and rear surfaces of which are opened, and includes a plurality of lifters 21 protruded in a mountain shape from the inner surface thereof for lifting laundry and then dropping the laundry. A front support plate 22 and a rear support plate 23, which are installed in the external case 10, rotatably support front and rear opened surfaces of the rotary drum 20 and cover the front and rear opened surfaces of the rotary drum 20.

A front support protrusion 24 and a rear support protrusion 25 are respectively formed on the front support plate 22 and the rear support plate 23, and are protruded such that the front and rear support protrusions 24 and 25 respectively enter the front and rear opened surfaces of the rotary drum 20, thereby rotatably supporting the front and rear opened surfaces of the rotary drum 20. Friction reducing members 26 made of a non-woven fabric for reducing friction between the front support protrusion 24 and the rotary drum 20 and between the rear support protrusion 25 and the rotary drum 20 when the rotary drum 20 is rotated are interposed between the front support protrusion 24 and the rotary drum 20 and between the rear support protrusion 25 and the rotary drum 20, and rollers 27 for supporting the lower part of the rotary drum 20 are installed at the lower parts of the front and rear support plates 22 and 23.

Openings 11a and 22a through which laundry is inserted into or taken out of the inside of the rotary drum 20 are respectively formed through a front surface 11 of the external case 10 and the front support plate 22, and a door 12 for opening and closing the openings 11a and 22a is installed on the front surface 11 of the external case 10.

The driving device 30 includes a driving motor 31 installed in the lower part of the external case 10, and a pulley 32 and a rotary belt 33 for transmitting the driving force of the driving motor 31 to the rotary drum 20. The rotary belt 33 is wound on the outer surface of the rotary drum 20 and the pulley 32 which is connected to a shaft 34 of the driving motor 31.

The suction channel 40 guides external air, thereby causing the external air to be introduced to the inside of the rotary drum 20. The suction channel 40 includes a lower suction duct 41 having a cylindrical structure installed below the rotary drum 20, and a rear suction duct 42 installed at the rear of the rotary drum 20 for connecting inlets 23a formed through the upper part of the rear support plate 23 and the lower suction duct 41. A burner 70 for heating sucked in air is installed at an inlet of the lower suction duct 41.

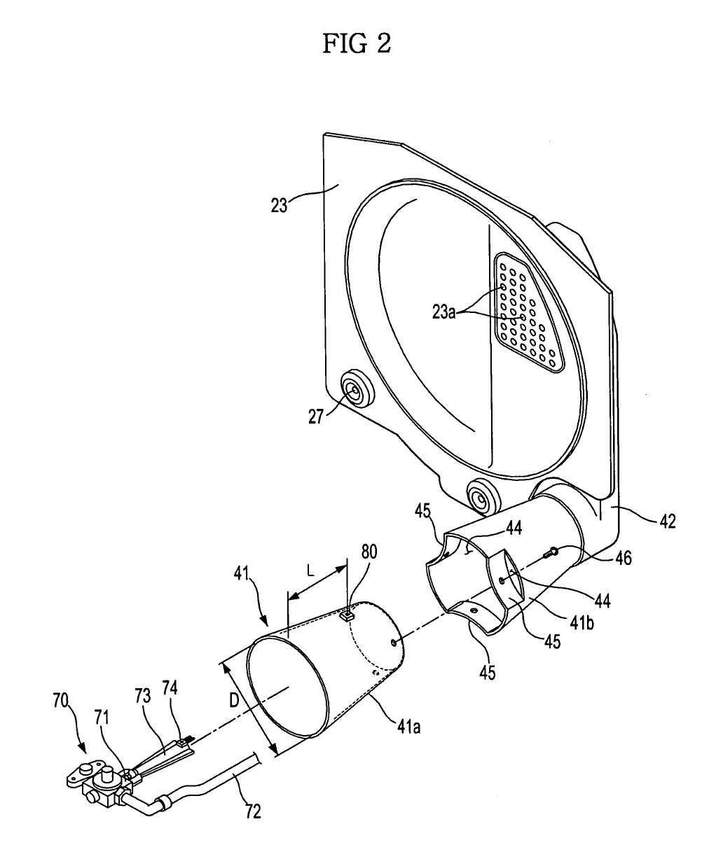

As shown in FIGS. 1 and 2, the lower suction duct 41 includes a first duct 41a and a second duct 41b, which are connected in series. The first duct 41a is located close to the burner 70, and one end of the second duct 41b is connected to an outlet of the first duct 41a and the other end of the second duct 41b is connected to an inlet of the rear suction duct 42. The first and second ducts 41a and 41b have a conical structure, the diameter of which is reduced from the inlet of each of the first and second ducts 41a and 41b to the outlet of each of the first and second ducts 41a and 41b. The first and second ducts 41a and 41b are connected such that the inlet of the second duct 41b having a large diameter overlaps the outer surface of the outlet of the first duct 41a having a small diameter, thereby forming an air inlet through a gap between the outlet of the first duct 41a and the inlet of the second duct 41b. The above construction allows air to be introduced into the suction channel 40 through the air inlet 44 of the lower suction duct 41, thereby sufficiently burning the flame emitted from the burner 70 and preventing soot on a designated position in the second duct 41b. In order to connect the first and second ducts 41a and 41b, connection portions 45, which are protruded inwardly to contact the outer surface of the outlet of the first duct 41a, are formed at the inlet of the second duct 41b, and connection screws 46 are inserted into the connection portions 45.

The discharge channel 50 guides air in the rotary drum 20, thereby causing the air to be discharged to the outside of the rotary drum 20. As shown in FIG. 1, the discharge channel 50 includes a front discharge duct 51 for connecting outlets 22b formed through the lower part of the front support plate 22 and an inlet of the air blowing device 60 installed below the rotary drum 20, and a rear discharge duct 52 installed in the lower part of the external case 10 for communicating an outlet of the air blowing device 60 with the outside of the rear surface of the external case 10.

The air blowing device 60 includes an air blast fan 61 installed at the shaft 34 of the driving motor 31 driving the rotary drum 20, and an air blowing case 62 surrounding the air blast fan 61 and having an inlet 62a and an outlet (not shown), which are respectively connected to the front and rear discharge ducts 51 and 52.

As shown in FIG. 2, the burner 70 includes a spraying device 71 connected to a gas supply pipe 72 for adjusting the spray of gas such as, for example, natural gas, a mixing pipe 73 having a designated length for mixing gas sprayed from the spraying device 71 with combustion air, and an igniter 74 installed at an outlet of the mixing pipe 73 for lighting the burner 70. The outlet of the mixing pipe 73 is disposed at the central portion of the inlet of the first duct 41a so that the burner 70 emits flame to the inside of the first duct 41a of the lower suction duct 41.

In the clothes drying machine of the present invention, the rotary drum 20 is rotated by the operation of the driving motor 31, and laundry contained in the rotary drum 20 is lifted and then dropped by the rotation of the rotary drum 20. Simultaneously, air is circulated into the rotary drum 20 by the operation of the air blast fan 61. The blowing of the air will be described as follows. Damp air in the rotary drum 20 is discharged to the outside through the front discharge duct 51, the air blowing case 62, and the rear discharge duct 52, and new air in the same amount as that of the discharged air is introduced to the inside of the rotary drum 20 through a lower opening 10a provided at a lower portion of the external case 10, the lower suction duct 41 and the rear suction duct 42. The air sucked in through the lower suction duct 41 is heated by the flame emitted from the burner 70, and is introduced to the inside of the rotary drum 20, thereby rapidly drying the laundry in the rotary drum 20.

In the drying operation, when the discharge channel 50 is clogged so that the amount of air passing through the rotary drum 20 is reduced (when a channel resistance is increased due to the large amount of laundry in the rotary drum or waste thread or lint present in the discharge channel), the sucked in air is overheated. In order to prevent the above overheating, the clothes drying machine of the present invention further comprises a temperature sensor 80 installed in the first duct 41a of the lower suction duct 41. The temperature sensor 80 controls the operation of the burner 70 by sensing the temperature. That is, the temperature sensor 80 stops the operation of the burner 70 when the temperature sensed by the temperature sensor 80 reaches the upper limit, thereby preventing the overheating of the sucked in air. The temperature sensor 80 is a conventional thermostat.

The temperature sensor 80 is installed at a position, the temperature of which is slowly increased when the flow of air is smooth due to the low degree of clogging in the channel and is rapidly increased when the flow of air is not smooth due to the high degree of clogging in the channel. That is, when air introduced into the rotary drum 20 is not overheated due to the low degree of clogging in the channel (small channel resistance), the temperature sensed by the temperature sensor 80 is low to minimize the stoppage of the operation of the burner 70, and when the degree of clogging in the channel is rapidly increased, the temperature sensed by the temperature sensor 80 is increased at a high speed to prevent the overheating of the air.

When the installation position of the temperature sensor 80 satisfies the above conditions, the lower the degree of clogging in the channel (channel resistance) is, the slower the increase of the temperature sensed by the temperature sensor 80 is, and the operation time of the burner 70 is lengthened. Further, in these conditions, the higher the degree of clogging in the channel is, the faster the increase of the temperature sensed by the temperature sensor 80 is, and the operation of the burner 70 is stopped so that the overheating of the air in the channel is prevented. The above temperature sensor 80 prevents the unnecessarily frequent stoppage of the operation of the burner 70, thus shortening the drying time of laundry.

The present applicants performed many tests and extensive research to determine the position of the temperature sensor 80, which meets the above conditions. As results of the tests and research, as shown in FIG. 2, the temperature sensor 80 met the above conditions when the temperature sensor 80 was installed at a position separated from the inlet of the first duct 41a in the direction to the outlet of the first duct 41a by a designated distance (L) and the ratio of the separation distance (L) to a diameter (D) of the inlet of the first duct 41a was 0.9˜1. That is, when the temperature sensor 80 is installed at the position in which the ratio of L/D is 0.9˜1, it is possible to minimize the stoppage of the operation of the burner 70, thereby shortening the drying time of laundry and preventing the overheating of air.

The test for determining the position of the temperature sensor 80 was performed by the following method.

The diameter (D) of the inlet of the suction duct 41 was approximately 140˜150 mm, the length of flame emitted from the burner 70 to the inside of the suction duct 41 was maintained in the range of 140˜160 mm, and the operation of the air blast fan 61 was uniform.

The installation position of the temperature sensor 80 was varied, and variation in temperature sensed by the temperature sensor 80 at each position was checked after one minute from the start of the operation of the burner 70. Then, variation in temperature sensed by the temperature sensor 80 at each position under the condition that channel opening conditions (channel resistance conditions) of each position vary.

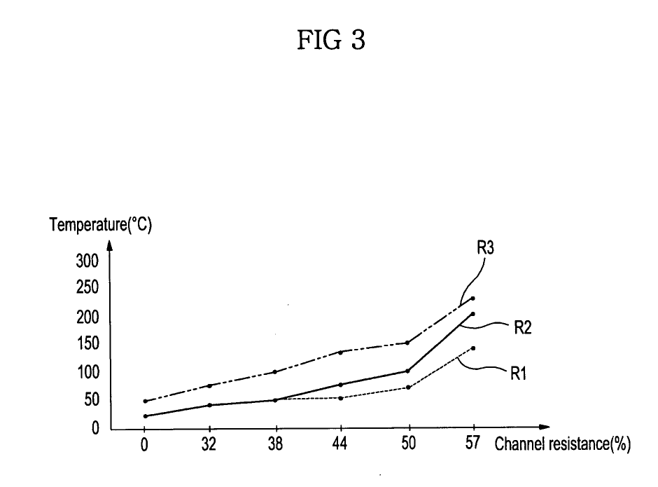

Test results are illustrated in FIG. 3. A graph of FIG. 3 illustrates variation in temperature according to variation in channel resistance under the condition that the installation positions of the temperature sensor 80 meet the conditions of R1(L/D=0.35), R2(L/D=0.95), and R3(L/D=1.55). In FIG. 3, the channel resistance was gradually increased from left to right. For example, a channel resistance of 57% denotes that 57% of the channel is clogged.

As test results, when the installation positions of the temperature sensor 80 meet the conditions of R1(L/D=0.35) and R3(L/D=1.55), the increase of temperature is not rapid according to the increase of channel resistance. On the other hand, when the installation position of the temperature sensor 80 meets the conditions of R2(L/D=0.95), in the case that the degree of clogging of the channel (channel resistance) is low, the increase of temperature is slow, and in the case that the degree of clogging of the channel is high, the increase of temperature is rapid.

That is, when the temperature sensor 80 is installed under the similar conditions to those of R2(L/D=0.95), the lower the channel resistance is, the slower the increase of temperature sensed by the temperature sensor 80 is, and the operating time of the burner 70 is lengthened as much. The higher the channel resistance is, the faster the increase of temperature sensed by the temperature sensor 80 is, and the operation of the burner 70 is stopped so that the overheating of air in the channel is prevented.

As apparent from the above description, the present invention provides a clothes drying machine, in which a temperature sensor is installed at a position, in which the ratio of a distance (L) separated from an inlet of a suction duct to a diameter (D) of the inlet of the suction duct is 0.9˜1, so that the lower a channel resistance in a channel is, the slower the increase the temperature sensed by a temperature sensor is, thereby minimizing the stoppage of the operation of a burner and shortening the drying time of laundry.

Although an exemplary embodiment of the invention has been shown and described, it would be appreciated by those skilled in the art that changes may be made in this embodiment without departing from the principles and spirit of the invention, the scope of which is defined in the claims and their equivalents.

What is claimed is:

1. A clothes drying machine, comprising:
a suction duct for guiding air to be introduced to a rotary drum;
a burner for heating air introduced into the suction duct; and
a temperature sensor installed in the suction duct for controlling the operation of the burner,
wherein the temperature sensor is installed at a position separated from an inlet of the suction duct by a designated distance, and the ratio of the distance to a diameter of the inlet of the suction duct is 0.9˜1.

2. The clothes drying machine as set forth in claim 1,
wherein the ratio of the distance to the diameter of the inlet of the suction duct is 0.95.

3. The clothes drying machine as set forth in claim 2,
wherein the diameter of the inlet of the suction duct is 140˜150 mm, and the length of flame emitted from the burner is 140˜160 mm.

4. The clothes drying machine as set forth in claim 3,
wherein the suction duct has a conical structure, a diameter of which is reduced from the inlet to the outlet.

5. The clothes drying machine as set forth in claim 1, wherein the temperature sensor is a thermostat.

6. The clothes drying machine as set forth in claim 1, wherein:
the suction duct includes a lower suction duct installed below the rotary drum, and a rear suction duct installed at a rear of the rotary drum; and
the temperature sensor is installed in the lower suction duct.

7. The clothes drying machine as set forth in claim 6, wherein the lower suction duct includes a first duct and a second duct which are connected in series.
